(19) United States
(12) Patent Application Publication
(10) Pub. No.: US 2005/0071499 A1
(43) Pub. Date: Mar. 31, 2005

(54) Real-time diagnostic data streams for tunable optical devices

(76) Inventors: Rajesh K. Batra, Palo Alto, CA (US); Ken P. Koller, San Francisco, CA (US); Jiann-Chang Lo, Cupertino, CA (US); Andrew Daiber, Emerald Hills, CA (US); Mark S. Rice, San Jose, CA (US); David K. Thiesen, Bakersfield, CA (US)

Correspondence Address: Anthony H. Azure;BLAKELY, SOKOLOFF, TAYLOR & ZAFMAN LLP, Seventh Floor, 12400 Wilshire Boulevard, Los Angeles, CA, 90025, US

(21) Appl. No.: 10/675,825

(22) Filed: Sep. 30, 2003

(51) Int. Cl. G06F 15/16

(52) U.S. Cl. 709/236

(57) ABSTRACT

An apparatus and method to provide real-time diagnostic data streams for a tunable optical device. Data from a tunable optical device is captured in real-time during operation of the tunable optical device. The data is formatted into data frames and streamed from the tunable optical device via a serial interface. The data is received at a data acquisition unit and stored at a storage device. The data gathered during the operation of the tunable optical device may be studied later to review operations of the tunable optical device and to diagnose errors.

### BACKGROUND

1. Field of Invention

The field of invention relates generally to tunable optical devices and, more specifically, relates to real-time diagnostic data streams for tunable optical devices.

2. Background Information

Optical networks have been implemented in a variety of applications such as telecommunications and computer networking. Optical networks employ a variety of components including tunable optical devices. Tunable optical devices offer flexibility, speed, and bandwidth to optical networks.

Tunable optical devices under varying operating and environmental conditions can exhibit unexpected behaviors in sub-second time frames. These aberrations can be minuscule resulting in occasional, seemingly indeterminate, abnormalities to a system. However, these subtle aberrations can compound upon one another resulting in a major system failure. Often, minor anomalies are only discovered after the tunable optical device has been deployed and integrated into an optical communication system. Testing of tunable optical devices fails to discover these minor flaws because the test cases fail to capture the specific set of operating conditions that cause the system to become unstable in the field.

Today's optical communication systems do not offer real-time data streaming of tunable optical devices. Some optical tunable systems output prepared error messages if a failure of a tunable optical system occurs. However, with the growing complexity of optical systems, these error-handling routines fail to anticipate all possible errors. Additionally, without a consistent manner of collecting diagnostic data, it is difficult for system manufacturers, vendors, and customers to share information regarding the operations of their tunable optical devices.

### BRIEF DESCRIPTION OF THE DRAWINGS

The present invention is illustrated by way of example and not limitation in the accompanying figures.

FIG. 1 is a schematic diagram illustrating one embodiment of real-time diagnostic data streaming from a tunable optical device in accordance with the teachings of the present invention.

FIG. 2 is a flowchart illustrating one embodiment of real-time diagnostic data streaming from a tunable optical device in accordance with the teachings of the present invention.

FIGS. 3 is a diagram illustrating one embodiment of a data frame for real-time diagnostic data streaming from a tunable optical device in accordance with the teachings of the present invention.

FIG. 4 is a schematic diagram illustrating one embodiment of real-time diagnostic data streaming from a tunable optical device in accordance with the teachings of the present invention.

FIG. 5 is a schematic diagram illustrating one embodiment of a computer system in accordance with the teachings of the present invention.

### DETAILED DESCRIPTION

Methods and apparatuses to provide real-time diagnostic data streaming for a tunable optical device are disclosed. In the following description numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner in one or more embodiments. In addition, it is appreciated that the figures provided herewith are for explanation purposes to persons ordinarily skilled in the art and that the drawings are not necessarily drawn to scale.

In one embodiment of the present invention, a mechanism is disclosed to provide real-time diagnostic data streams for tunable optical devices. Various data points, such as laser temperature, laser power, laser frequency, are captured and streamed from a tunable optical device in real-time. The captured data is stored and may be analyzed at a later time. The data history may be fed into a simulator or tunable optical device to study what occurred while the optical device was operating. Also, the data is streamed and collected in a standardized format so that the data can be conveniently passed and utilized by various entities having interest in the data.

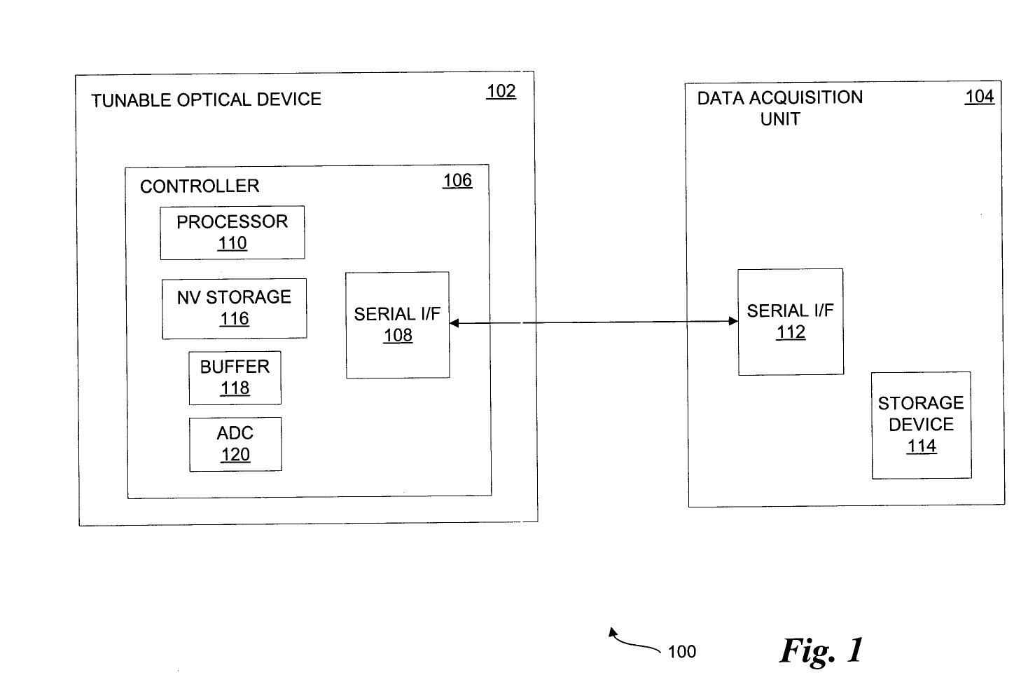

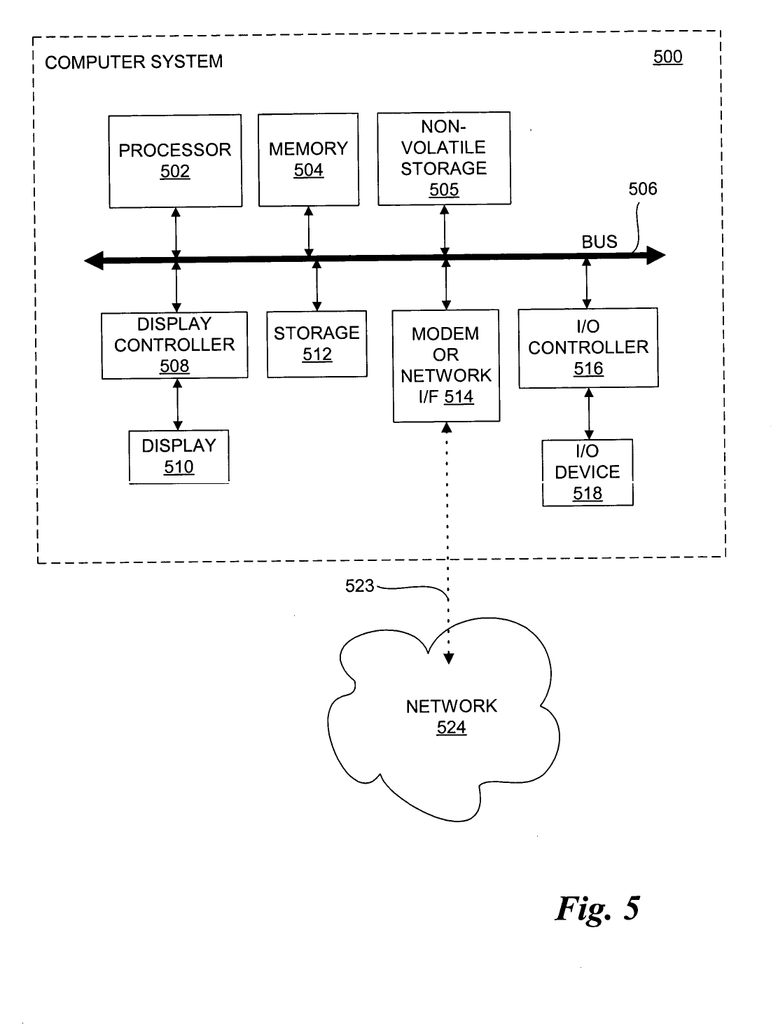

In FIG. 1, an embodiment of the present invention is shown generally at 100. A tunable optical device 102 is communicatively coupled to a data acquisition unit 104. The tunable optical device 102 includes, but is not limited to, a tunable laser, an optical transponder, or the like. Data acquisition unit 104 receives data sent by the tunable optical device 102 and forwards the data to a storage device. In one embodiment, data acquisition unit 104 is a computer system as described below in conjunction with FIG. 5. Data acquisition unit 104 includes, but is not limited to, a personal computer, a laptop computer, a personal digital assistant, a handheld test unit, a custom built-data acquisition unit, or the like.

The tunable optical device 102 is coupled to a controller 106. In one embodiment, the controller 106 may be an internal component of tunable optical device 102. In another embodiment, the controller 106 is provided as an add-on component to be installed in the tunable optical device 102. For example, a controller may be fit for a circuit board of a tunable optical device and drive the Input/Output pins of the tunable optical device.

The controller 106 includes a processor 110. The processor 110 may be a conventional processor including, but not limited to, an Intel Corporation family processor (e.g., 80L 186EC and other x86, Pentium, Itanium processor, etc.), a Motorola family processor (e.g., 68K/Coldfire, etc.), a Texas Instrument family processor (e.g., TMS320C28x, etc.) or the like.

The processor 110 is coupled to a serial interface 108. The serial interface 108 includes, but is not limited to, an SPI (Serial Peripheral Interface), a UART (Universal Asynchronous Receiver/Transmitter), an I2C (Inter-Integrated Circuit), a USB (Universal Serial Bus) system, or a SCSI (Small Computer System Interface), or the like.

In the embodiment shown in FIG. 1, the controller 106 includes non-volatile storage unit 116, a buffer 118, and an ADC (Analog-to-Digital Converter) 120, each coupled to the processor 110 via a bus (not shown). The non-volatile storage unit 116 stores firmware instructions that may be executed by the processor 110 to stream real-time data from the tunable optical device 102. The buffer 118 provides temporary storage of data captured from the tunable optical device 102 before the data is sent from the tunable optical device 102. The ADC 120 may be used to convert analog data captured from the tunable optical device 102 into a digital form before the data is streamed from the tunable optical device 102.

Data acquisition unit 104 includes serial interface 112. Serial interface 112 is similar to the serial interface 108 as described above and is designed to receive the data transmission from the serial interface at the tunable optical device over a specified protocol. In one embodiment, data acquisition unit 104 includes a storage device 114. In another embodiment, data acquisition unit 104 is coupled to storage device 114 over a wired connection, a wireless connection, or a computer network connection. Storage device 114 includes, but is not limited to, a magnetic disk, an optical disk, Random Access Memory (RAM), or the like.

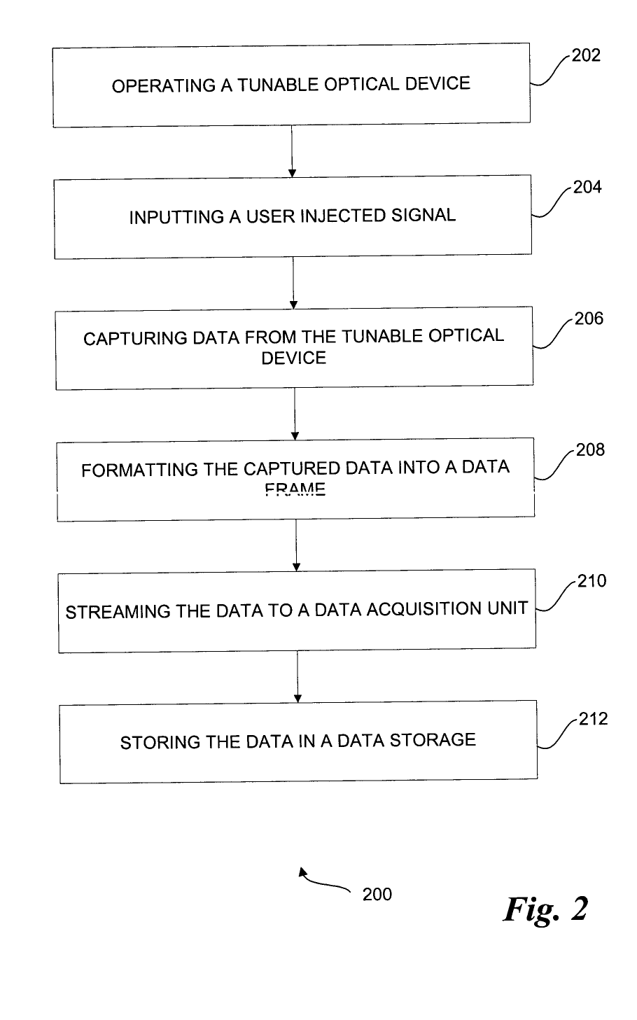

FIG. 2 shows a flowchart 200 according to one embodiment of the present invention to stream real-time data from a tunable optical device. FIG. 2 is discussed in conjunction with the embodiment of FIG. 1. In a block 202, a tunable optical device is operating. It will be appreciated that data is captured from the tunable optical device during real-time operation.

In a block 204, a user injected signal is inputted into the tunable optical device. In one embodiment, the user injected signal is a “contrived” or “artificial” signal to change an operating factor of the tunable optical device to determine how the tunable optical device responds. The response will be recorded as the real-time data is streamed from the tunable optical device. For example, in one embodiment, the user injected signal may artificially change the enclosure temperature of the tunable optical device. This user injected signal would be routed to a temperature input reading of the tunable optical device. The controller, responding to this change in temperature, would then send an output to a thermo-electric cooler. The real-time data stream will show how the tunable optical device responds to such an “artificial” change in operating conditions by capturing both the input and output signals. In one embodiment, data can be captured while the tunable optical device is manipulated via user injected signals to create bode-plots.

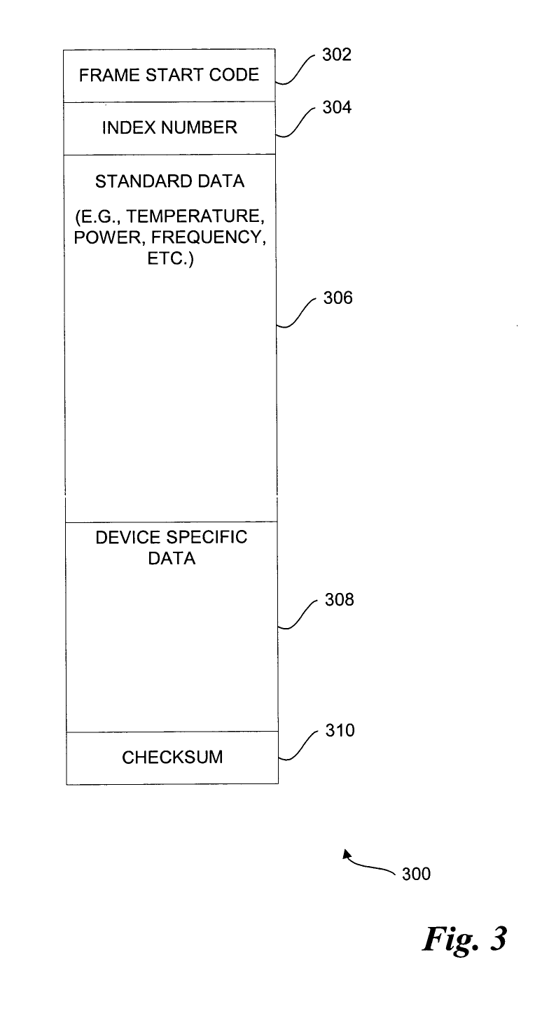

In one embodiment, the user injector signal is provided as an analog or digital signal to the tunable optical device 102. In one embodiment, ADCs may be allotted for the purpose of inputting analog injector signals. For example, the user injected signal may be inputted directly into the ADC 120. The controller may use such a spare signal as a control input. In another embodiment, the user injector signal is provided to the tunable optical device through the serial interface 108. This circumvents the need for an analog line which can take additional resources and costs. In one embodiment, the user injector signal may be sent to the tunable optical device 102 from the data acquisition unit 104 using the Master In Slave Out (MISO) line of an SPI of the controller 106 (discussed further below in conjunction with FIG. 3).

Proceeding to a block 206, data is captured from the tunable optical device during its operation. In one embodiment, controller 106 receives data points regarding various aspects of the tunable optical device 102. These data points include, but are not limited to, laser temperature, laser power, laser frequency, laser current, error signals, internal servo parameters, fault and warning conditions, or the like. These data points are periodically collected and grouped based on the moment in time the data points were collected.

In one embodiment, the data is captured at a rate based on the processing speed of the controller. In one embodiment, for a 100 Hz real-time controller, the real-time data is captured every 10 milliseconds (ms). If the communication speed of the serial interface of the tunable optical device is not comparable to the capture rate of the controller, then the captured data can be buffered. The buffered data will be streamed from the tunable optical device at a rate achievable by the communication path out of the tunable optical device. For example, the processor may operate at 25 Mhz, but the serial interface can be driven at a maximum of 10 Mhz.

Some of the data may be captured in a digital format, while other data originates as analog data. In some instances, the reading device or other controller can provide the information in a digital format by using its own analog-digital-converter. In one embodiment, the controller 106 includes an analog-to-digital converter in case any data points captured as analog data need to be converted into digital data prior to being sent from the tunable optical device.

In a block 208, the captured data is formatted into a data frame. The data frame provides a standardized way of outputting the data from the tunable optical device. This also allows the data to be stored in a standardized fashion to allow easy transferal and utilization by others.

Referring to FIG. 3, an embodiment of a data frame 300 is shown. It will be understood that the information in data frame 300 is not limited to the arrangement shown. The first section of the data frame 300 is a frame start code 302. The frame start code 302 indicates the beginning of the data frame 300. In one embodiment, frame start code 302 is a 16-bit value, while in another embodiment, the frame start code 302 is a 32-bit value. In one embodiment, the value of the frame start code is irrelevant, only that the frame start code provides a way for the data acquisition unit to identify the start of a new frame. In yet another embodiment, the start frame may be encompassed by the communication interface. For example, the SPI select signal may be seen as a start of frame and the end of frame may be viewed as the deselect signal (SPI discussed further below). This scheme can reduce the amount of digital data sent across the communication interface.

Data frame 300 also includes an index number 304. The index number 304 indicates the order that packets have been sent from the tunable optical device; each time a new frame is formed, the index number is increased by one. The index number 304 may be used by the data acquisition unit to determine if any data frames have been dropped during transmission to the data acquisition unit. In one embodiment, the index number 304 is a value from 0 to 255. Once the value of the index number 304 has reached 255, the value assigned to the index number 304 will start again at 0.

Data frame 300 also includes a standard data section 306. The standard data section 306 includes data that would normally be captured from a tunable optical device. Examples of such standard data include laser temperature, laser power, and laser frequency. In one embodiment, the standard data section 306 is information collected from tunable optical devices regardless of the vendor or manufacturer of the tunable optical device.

A device specific section 308 is also included in data frame 300. The device specific section 308 includes information captured that is specific to that device or technology. The device specific section 308 allows the tunable optical device to report operating parameters not common to all tunable optical devices. For example, a tunable optical device from a certain manufacturer may contain a particular servo motor. The device specific section 308 may contain a data field to report a data point regarding this servo motor, such as motor speed, current, temperature, etc., that would be of interest to that particular tunable optical device.

In one embodiment, the data frame may also include a checksum 310. The checksum can notify the user if any of the data in the data frame has been corrupted in transmission. This provides the user the option of throwing out flawed data frames.

Referring again to FIG. 2, in a block 210, the captured data is streamed from the tunable optical device to a data acquisition unit. Each data frame streamed from the tunable optical device includes data points captured at a particular time. For example, data frame 1 includes data points captured at time 1 and data frame 2 includes the same data points captured at time 2. In one embodiment, the real-time data is collected, formatted, and provided to the serial interface of the controller during operation of the tunable optical device. A data acquisition unit communicatively coupled to the tunable optical device can choose to ignore the data stream accessible at the serial interface. In another embodiment, data is forwarded from the reserved pins to the serial interface in response to a request to the tunable optical device for the output of data. In yet another embodiment, data is forwarded from the reserved pins to the serial interface in response to a user injected signal inputted into the tunable optical device.

In a block 212, the data acquisition unit stores the streamed data in a storage device communicatively coupled to the data acquisition unit. In this way, the data can be analyzed later to develop a timeline of events. Data is collected as the tunable optical device operates, the system does not have to be brought down in order to run diagnostic routines that may be embedded within the controller. Also, the data can be fed into a simulator or actual optical device to replay the operations of the tunable optical device and understand the behaviors of the tunable optical device in relation to environmental factors. The real-time data may be used to diagnose noise problems, electrical cross-talk, and controller loss. The data may also be used to analyze servo control of a tunable optical device.

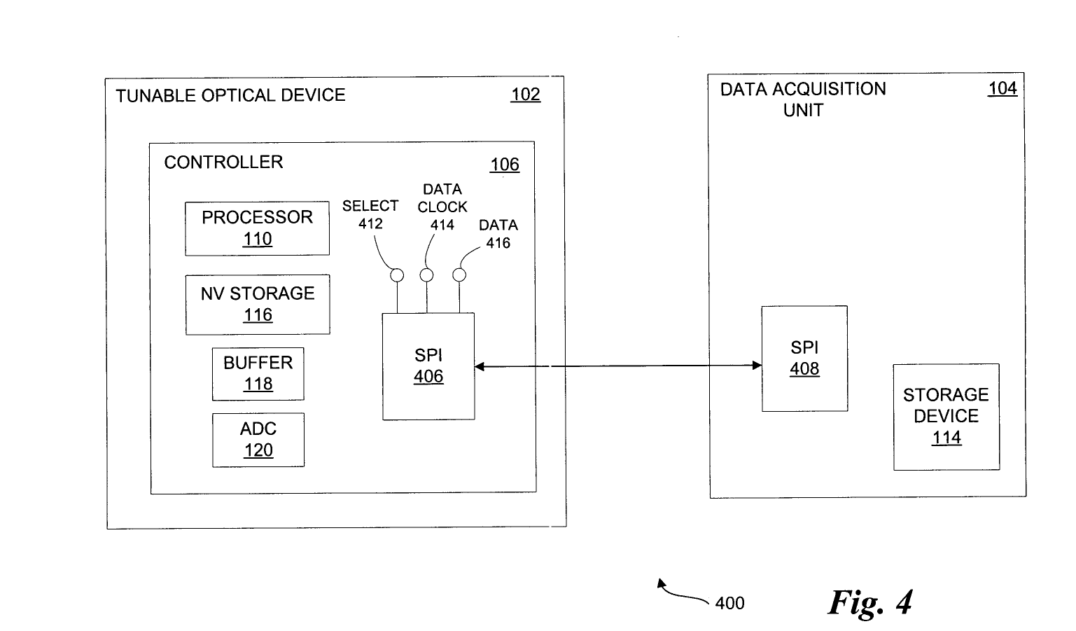

Referring to FIG. 4, another embodiment of the present invention is shown at 400. It will be understood that like reference numbers from FIG. 1 refer to like objects in FIG. 4. In FIG. 4, the controller 106 includes a Serial Peripheral Interface (SPI) 406 as a serial interface. The data acquisition unit 104 also contains an SPI 408. In one embodiment, the data acquisition unit 408 does not have a SPI, but is coupled to a converter (not shown) to convert SPI packets into USB packets for data acquisition unit 104. An example converter includes, but is not limited to, an Aardvark™ 12C/SPI Host Adapter, Total Phase Corporation, Sunnyvale, Calif.

SPI is a serial bus protocol that operates in full duplex and supports high bandwidth connections (up to 10 megabaud). Devices communicate with SPI using a master/slave relationship, in which the master initiates the data transfer. The SPI system includes two data lines and two control lines. A Master Out Slave In (MOSI) line supplies the output data from the master to the slave(s). The Master In Slave Out (MISO) line provides output data from a slave to the input of the master. The Serial Clock (SCLK) line is driven by the master and regulates the flow of the data. The Slave Select (SS) line is a control line that allows the master to select a slave device. If multiple slave devices exist, the master may generate a separate slave select signal for each slave. In one embodiment, SPI 406 is the master SPI and the SPI 408 is the slave SPI.

In one embodiment, the controller 106 includes a set of reserved pins. The reserved pins include a select pin 412, a data clock pin 414, and a data pin 416. The select pin 412 is used to signal the data acquisition unit 104 to prepare to receive a data stream. The data clock pin 414 clocks the data at a prescribed data rate from the tunable optical device. The data pin 416 outputs the captured data at the data rate of the data clock pin 414. The reserved pins 412, 414 and 416 are routed to the SPI 406. This allows vendors and customers to use SPI 406 to capture and store real-time data streams from the tunable optical device 102. In one embodiment, the data rate of the data clock pin 414 is 1 Mhz.

FIG. 5 is an illustration of one embodiment of an example computer system 500 that can be used with embodiments of the present invention. Computer system 500 includes a processor 502 coupled to a bus 506. Memory 504, storage 512, non-volatile storage 505, display controller 508, input/output controller 516 and modem or network interface 514 are also coupled to bus 506. The computer system 500 may also include a serial interface (not shown) coupled to bus 506.

The computer system 500 may interface to external systems through the modem or network interface 514. This interface 514 may be an analog modem, Integrated Services Digital Network (ISDN) modem, cable modem, Digital Subscriber Line (DSL) modem, a T-1 line interface, a T-3 line interface, token ring interface, satellite transmission interface, or other interfaces for coupling a computer system to other computer systems. A carrier wave signal 523 is received/transmitted by modem or network interface 514 to communicate with computer system 500. In the embodiment illustrated in FIG. 5, carrier waive signal 523 is used to interface computer system 500 with a computer network 524, such as a local area network (LAN), wide area network (WAN), or the Internet. In one embodiment, computer network 524 is further coupled to a remote computer (not shown), such that computer system 500 and the remote computer can communicate.

Processor 502 may be a conventional microprocessor including, but not limited to, an Intel Corporation x86, Pentium, or Itanium family microprocessor, a Motorola Corporation family microprocessor, or the like. Memory 504 may include, but is not limited to, Dynamic Random Access Memory (DRAM), Static Random Access Memory (SRAM), Synchronized Dynamic Random Access Memory (SDRAM), Rambus Dynamic Random Access Memory (RDRAM), or the like. Display controller 508 controls in a conventional manner a display 510, which in one embodiment may be a cathode ray tube (CRT), a liquid crystal display (LCD), and active matrix display or the like. An input/output device 518 coupled to input/output controller 516 may be a keyboard, disk drive, printer, scanner and other input and output devices, including a mouse, trackball, trackpad, joystick, or other pointing device.

The computer system 500 also includes non-volatile storage 505 on which firmware and/or data may be stored. Non-volatile storage devices include, but are not limited to, Read-Only Memory (ROM), Flash memory, Erasable Programmable Read Only Memory (EPROM), Electronically Erasable Programmable Read Only Memory (EEPROM), or the like.

Storage 512 in one embodiment may be a magnetic hard disk, an optical disk, or another form of storage for large amounts of data. Some data may be written by a direct memory access process into memory 504 during execution of software in computer system 500. It is appreciated that software may reside in storage 512, memory 504, non-volatile storage 505 or may be transmitted or received via modem or network interface 514.

For the purposes of the specification, a machine-readable medium includes any mechanism that provides (i.e., stores and/or transmits) information in a form readable or accessible by a machine (e.g., a computer, network device, personal digital assistant, manufacturing tool, any device with a set of one or more processors etc.). For example, a machine-readable medium includes, but is not limited to, recordable/non-recordable media (e.g., a read only memory (ROM), a random access memory (RAM), a magnetic disk storage media, an optical storage media, a flash memory device, etc.). In addition, a machine-readable medium can include propagated signals such as electrical, optical, acoustical or other form of propagated signals (e.g., carrier waves, infrared signals, digital signals, etc.).

It will be appreciated that computer system 500 is one example of many possible computer systems that have different architectures. For example, computer systems that utilize Microsoft Windows operating system in combination with Intel microprocessors often have multiple buses, one of which may be considered a peripheral bus. Network computers may also be considered as computer systems that may be used with the present invention. Network computers may not include a hard disk or other mass storage, and the executable programs are loaded from a corded or wireless network connection into memory 504 for execution by processor 502. In addition, handheld or palmtop computers, which are sometimes referred to as personal digital assistants (PDAs), may also be considered as computer systems that may be used with the present invention. As with network computers, handheld computers may not include a hard disk or other mass storage, and the executable programs are loaded from a corded or wireless network connection into memory 504 for execution by processor 502. A typical computer system will usually include at least a processor 502, memory 504, and a bus 506 coupling memory 504 to processor 502.

It will also be appreciated that in one embodiment, computer system 500 is controlled by operating system software that includes a file management system, such as a disk operating system, which is part of the operating system software. For example, one embodiment of the present invention utilizes Microsoft Windows® as the operating system for computer system 500. In other embodiments, other operating systems that may also be used with computer system 500 include, but are not limited to, the Apple Macintosh operating system, the Linux operating system, the Microsoft Windows CE® operating system, the Unix operating system, the 3Com Palm operating system, or the like.

In the foregoing detailed description, the method and apparatus of the present invention have been described with reference to specific exemplary embodiments thereof. It will, however, be evident that various modifications and changes may be made thereto without departing from the broader spirit and scope of the present invention. The present specification and figures are accordingly to be regarded as illustrative rather than restrictive.

1. A method, comprising:
periodically capturing data from a tunable optical device during operation of the tunable optical device; and
streaming the data from the tunable optical device.

2. The method of claim 1 wherein streaming the data comprises outputting a plurality of data frames from a serial interface coupled to the tunable optical device, wherein each data frame of the plurality of data frames includes data captured from the tunable optical device at a particular time.

3. The method of claim 2, further comprising formatting the data into the plurality of data frames.

4. The method of claim 2 wherein each data frame includes a frame start code, an index number, a standard data section, and a device specific data section.

5. The method of claim 4 wherein each data frame includes a checksum.

6. The method of claim 1, further comprising buffering the captured data at the tunable optical device prior to streaming the data from the tunable optical device.

7. The method of claim 1, further comprising receiving a user injected signal at the tunable optical device to artificially change an operating factor of the tunable optical device.

8. The method of claim 7, further comprising routing the user injected signal to a controller of the tunable optical device.

9. The method of claim 1, further comprising receiving the data at a data acquisition unit communicatively coupled to the tunable device.

10. The method of claim 9, further comprising storing the data at a storage device communicatively coupled to the data acquisition unit.

11. An apparatus, comprising:
a tunable optical device; and
a controller coupled to the tunable optical device, the controller including a serial interface coupled to a processor, the controller to capture a plurality of sets of real-time data from the tunable optical device during operation of the tunable optical device, the controller to stream the plurality of sets of real-time data from the tunable optical device.

12. The apparatus of claim 11 wherein each set of the plurality of sets real-time data includes a plurality of data points regarding the tunable optical device captured at a unique time.

13. The apparatus of claim 11 wherein the serial interface comprises one of an SPI (Serial Peripheral Interface), a UART (Universal Asynchronous Receiver/Transmitter), an I2C (Inter-integrated Circuit), a USB (Universal Serial Bus) port, or a SCSI (Small Computer System Interface).

14. The apparatus of claim 11 wherein the serial interface is coupled to a select pin, a data clock pin, and a data pin of the controller, the select pin to signal a device communicatively coupled to the serial interface to prepare to receive the plurality of sets of real-time data, the data clock pin to indicate the data rate that the plurality of sets of real-time data are to be outputted from the serial interface, the data pin to output the plurality of sets of real-time data from the tunable optical device.

15. The apparatus of claim 11, further comprising a buffer coupled to the controller to temporarily store at least a portion of the plurality of sets of real-time data.

16. The apparatus of claim 11, further comprising an analog-to-digital (ADC) coupled to the controller to convert at least a portion of the plurality of sets of real-time data from analog to digital.

17. The apparatus of claim 11 wherein the plurality of sets of real-time data are captured at a periodic rate based on a processing speed of the processor.

18. A system, comprising:
a tunable optical device; and
a controller coupled to the tunable optical device, the controller comprising:
a processor; and
at least one flash device coupled to the processor, the at least one flash device including firmware instructions which when executed by the processor perform operations comprising:
capturing a first plurality of data points from the tunable optical device at a first time; and
streaming the first plurality of data points from the tunable optical device.

19. The system of claim 18 wherein execution of the firmware instructions further perform operations comprising forming the first plurality of data points into a first data frame.

20. The system of claim 19 wherein execution of the firmware instructions further perform operations comprising:
capturing a second plurality of data points from the tunable optical device at a second time;
forming the second plurality of data points into a second data frame; and
streaming the second plurality of data points from the tunable optical device.

21. A method, comprising:
receiving a data stream from a tunable optical device at a data acquisition unit, wherein the data stream includes data periodically captured from the tunable optical device; and
storing the data in a storage device communicatively coupled to the data acquisition unit.

22. The method of claim 21, further comprising receiving a select signal at the data acquisition unit to indicate to the data acquisition unit to prepare to receive the data stream.

23. The method of claim 21 wherein receiving the data stream comprises receiving a plurality of data frames at a serial interface coupled to the data acquisition unit, wherein each data frame of the plurality of data frames includes a plurality of data points captured from the tunable optical device at a particular time.

24. The method of claim 23 wherein each data frame of the plurality of data frames includes a frame start code, an index number, a standard data section, and a device specific data section.

25. The method of claim 24, further comprising synchronizing the receiving of the plurality of data frames through the index number of at least one data frame of the plurality of data frames.

26. The method of claim 21, further comprising sending a user injected signal from the data acquisition unit to the tunable optical device, wherein the user injected signal to artificially change an operating factor of the tunable optical device.

27. An article of manufacture comprising:
a machine-readable medium including a plurality of instructions which when executed perform operations comprising:
capturing real-time data from a tunable optical device during operation of the tunable optical device;
forming a plurality of data frames from the real-time data, each data frame of the plurality of data frames including at least one data point captured from the tunable optical device at a particular time; and
streaming the plurality of data frames from the tunable optical device.

28. The article of manufacture of claim 27 wherein streaming the plurality of data frames comprises sending the plurality of data frames from a serial interface coupled to the tunable optical device.

29. The article of manufacture of claim 28 wherein execution of the plurality of instructions further perform operations comprising taking the at least one data point from a buffer coupled to the serial interface to form a data frame of the plurality of data frames.

30. The article of manufacture of claim 28 wherein execution of the plurality of instructions further perform operations comprising sending a select signal to a select line of the serial interface to signal a device communicatively coupled to the tunable optical device to prepare to receive streaming of the plurality of data frames.
